(19) United States
(12) Patent Application Publication
(10) Pub. No.: US 2011/0139619 A1
(43) Pub. Date: Jun. 16, 2011

(54) NOBLE METAL CATALYST POWDER, GAS SENSOR ELEMENT USING NOBLE METAL CATALYST POWDER, AND GAS SENSOR

(75) Inventors: Masatoshi IKEDA, Hazu-gun (JP); Yasufumi Suzuki, Kariya-shi (JP); Hiroshi Matsuoka, Kariya-shi (JP)

(73) Assignees: NIPPON SOKEN, INC., Nishio-city (JP); DENSO CORPORATION, Kariya-city (JP)

(21) Appl. No.: 12/967,552

(22) Filed: Dec. 14, 2010

(30) Foreign Application Priority Data
Dec. 14, 2009 (JP) 2009-282681

(51) Int. Cl. G01N 27/30; B01J 23/46; B01J 23/44

(52) U.S. Cl. 204/427; 502/339

(57) ABSTRACT

A noble metal catalyst powder produced by using co-precipitation method is made of noble metal alloy particles containing Pa, Pd, and Rh. The noble metal alloy particles have an average particle size within a range of 0.2 μm to 2.0 μm. A standard deviation in content of each of Pa, Pd, and Rh is not more than 20 mass %. This standard deviation in content of each of Pa, Pd, and Rh is detected at not less than ten detection-points of the noble metal catalyst powder by quantitative elemental analysis. A gas sensor element has the noble metal catalyst powder. An A/F sensor is equipped with the gas sensor element using the noble metal catalyst powder.

### CROSS-REFERENCE TO RELATED APPLICATION

This application is related to and claims priority from Japanese Patent Application No. 2009-282681 filed on Dec. 14, 2009, the contents of which are hereby incorporated by reference.

### BACKGROUND OF THE INVENTION

1. Field of the Invention

The present invention relates to noble metal catalyst powder to be used for performing the combustion control of an internal combustion engine mounted to vehicles, gas sensor elements using the noble metal catalyst powder, and gas sensors equipped with the gas sensor element.

2. Description of the Related Art

Recently, it becomes a serious problem in environmental conservation to improve fuel consumption of internal combustion engines mounted to vehicles. In order to cope with this serious problem, namely, to improve fuel consumption, internal combustion engine with gasoline direct injection (GUI) and other internal combustion engines using alternative fuel such as CNG (Compressed Natural Gas) have been used. Hereinafter, the engines of GDI type will be called to “GDI engines”, and the engines of CNG type will be called to “CNG engines”. In addition to the above recent trend, gas sensors to be mounted and fitted to the GUI engines and the CNG engines have been developed and used in order to perform the combustion control thereof.

In particular, the GDI engine emits exhaust gas containing un-burned gas when the GDI engine starts because such GUI engines have a different structure from ordinary internal combustion engines. Further, such a CNG engine emits exhaust gas richer in hydrogen (H₂) gas when compared with the exhaust gas emitted from ordinary-used internal combustion engines because such a CNG engine uses CNG which is different in composition from the fuel used by ordinary-used internal combustion engines. This often causes a serious problem to delay a detection signal output from the gas sensor used in the GDI engine and the CNG engine.

The above conventional serious problem to cause the output delay of the detection signal from the gas sensor is generated on the basis of a difference in diffusion speed between hydrogen (H₂) gas and other combustion gases such as oxygen (O₂) gas which pass through a porous diffusion resistance layer formed in the gas sensor. That is, hydrogen (H₂) gas reaches a target gas electrode faster than other combustion gases such as oxygen (O₂) gas, and an excess amount of hydrogen (H₂) gas is thereby generated around the target gas electrode in the gas sensor. This causes the output delay of the detection signal of the gas sensor.

In order to solve the above conventional problem, there are conventional techniques, for example, Japanese patent laid open publication No. JP 2007-199046 has proposed a gas sensor element having an improved structure in which a catalyst supporting trap layer supporting noble metal catalyst is formed on an outer peripheral surface of a porous diffusion resistance layer. A target gas to be detected, such as exhaust gas emitted from an internal combustion engine, passes through the porous diffusion resistance layer, and then reaches the target gas electrode. In the gas sensor element having the above structure, the catalyst supporting trap layer is formed on the outer peripheral surface of the porous diffusion resistance layer. The catalyst supporting trap layer supports noble metal catalysts such as Pt (platinum), Pd (palladium), and Rh (rhodium). Hydrogen (H₂) gas is oxidized by using these noble metal catalysts in order to suppress hydrogen (H₂) gas from reaching the target gas electrode. This prevents the output detection signal of the gas sensor element from being delayed.

However, the conventional technique disclosed in JP 2007-199046 has a drawback in which some of the noble metal catalysts supported by the catalyst supporting trap layer are evaporated during the working of the gas sensor element in a high temperature environment because of being placed near the internal combustion engine. This often causes the deterioration of the catalyst performance of the noble metals.

In addition, during the manufacturing process, the catalyst supporting trap layer is formed on the porous diffusion resistance layer in the gas sensor element by immersing a supporting trap layer into a solution containing noble metal, and then baking it. This makes the catalyst supporting trap layer with the noble metal having an average particle size of approximately 0.1 μm which is a very small size. Accordingly, some of the noble metal supported in the catalyst supporting trap layer is easily evaporated under a high temperature environment, for example, during the working of the internal combustion engine.

Still further, during the manufacturing process by the conventional technique, Pd (palladium) is firstly deposited on the surface of the catalyst supporting trap layer, Rh (rhodium) is then deposited on the catalyst supporting trap layer by using Pt (platinum) as a core element when noble metal catalyst powder is supported on the catalyst supporting trap layer in the gas sensor element. This conventional technique often generates inconsistency in distribution of Pt (platinum), Pd (palladium), and Rh (rhodium) on the catalyst supporting trap layer formed on the porous diffusion resistance layer of the gas sensor element. Accordingly, experimental results detected by SEM (scanning electron microscope) show that the gas sensor element produced by the above conventional technique has more than 20 mass % of the standard deviation in content of Pt (platinum), Pd (palladium), and Rh (rhodium) supported on the catalyst supporting trap layer.

On the other hand, there is another conventional technique which increases the average particle size of the noble metal in order to improve the duration of the noble metal in the gas sensor element. However, it is difficult to completely suppress the noble metal from being evaporated when the noble metal supported in the gas sensor element has a large average particle size and the gas sensor element is used under a high temperature environment. The evaporation of the noble metal supported in the gas sensor element decreases the catalyst performance of the noble metal catalyst supported in the gas sensor element.

There is also another conventional technique in order to avoid the above conventional problem, in which the catalyst supporting trap layer supports a large amount of noble metal in advance. However, this conventional technique increases the manufacturing cost for producing the gas sensor element because of using a lot of noble metal.

### SUMMARY OF THE INVENTION

It is an object of the present invention to provide a noble metal catalyst powder, a gas sensor element using the noble metal catalyst powder, and a gas sensor equipped with the gas sensor element. The gas sensor element using the noble metal catalyst powder, and the gas sensor equipped with the gas sensor element according to the present invention have the superior catalyst performance such as a superior heat resistance and a high durability.

To achieve the above purposes, the present invention provides a noble metal catalyst powder composed of noble metal alloy particles containing Pt (platinum), Pd (palladium), and Rh (rhodium). In particular, the noble metal alloy particles forming the noble metal catalyst powder have an average particle size within a range of 0.2 μm to 2.0 μm. A standard deviation in content of each of platinum, palladium, and rhodium is not more than 20 mass %. The standard deviation in content is detected at not less than ten detection points of the noble metal catalyst powder by quantitative elemental analysis.

The noble metal catalyst powder according to the first aspect of the present invention is made of noble metal alloy particles containing platinum, palladium, and rhodium. That is, the first aspect of the present invention provides the noble metal alloy composed of Pt (platinum) having a superior catalyst performance, Pd (palladium) having a high melting point, a superior heat resistance and a superior oxidation resistance (stabilization in oxygen atmosphere), and Rh (rhodium) having a high melting point and a superior heat resistance. The noble metal alloy particles in the noble metal catalyst powder according to the first aspect of the present invention can suppress the noble metal (in particular, Pt (platinum)) from being evaporated at high temperature under oxygen atmosphere.

In the first aspect of the present invention, the quantitative elemental analysis of Pt (platinum), Pd (palladium), and Rh (rhodium) was used at not less than ten detection points which were optionally selected in the noble metal catalyst powder. The detection results of the noble metal catalyst powder according to the first aspect of the present invention show that the standard deviation of content of each of Pt (platinum), Pd (palladium), and Rh (rhodium) contained in the noble metal catalyst powder is not more than 20 mass %. The standard deviation shows the degree in scattering of composition between Pt (platinum), Pd (palladium), and Rh (rhodium) in the noble metal catalyst powder.

That is, the noble metal catalyst powder according to the first aspect of the present invention has the superior characteristics in which each of Pt (platinum), Pd (palladium), and Rh (rhodium) is uniformly mixed in the noble metal catalyst powder in addition to making the alloy of Pt (platinum), Pd (palladium), and Rh (rhodium) while keeping the standard deviation in content of each of Pt (platinum), Pd (palladium), and Rh (rhodium) within not more than 20 mass %. This makes it possible to suppress the noble metal contained in the noble metal catalyst powder from being evaporated, and to provide the superior catalyst performance such as a superior heat resistance and a high duration for a long period of time and a long lifetime even if the noble metal catalyst powder is used under harsh condition such as a high temperature environment.

The noble metal alloy particles in the noble metal catalyst powder according to the first aspect of the present invention has the average particle size within the range of 0.2 μm to 2.0 μm. Having the above range of the average particle size of the noble metal alloy particles makes it possible to show the superior effects of suppressing the noble metal in the noble metal catalyst powder from being evaporated, and of keeping the specific surface area of the noble metal alloy particles in the noble metal catalyst powder, and of providing the superior catalyst performance of the noble metal catalyst powder.

In accordance with a second aspect of the present invention, there is provided a noble metal catalyst powder composed of noble metal alloy particles containing platinum and palladium. In the noble metal catalyst powder, the noble metal alloy particles have an average particle size within a range of 0.2 μm to 2.0 μm and the standard deviation in content of each of platinum and palladium is not more than 20 mass %. In particular, the standard deviation in content is detected at not less than ten detection points which were optionally selected in the noble metal catalyst powder by quantitative elemental analysis.

That is, the noble metal catalyst powder according to the second aspect of the present invention is made of noble metal alloy particles containing Pt (platinum) and Pd (palladium). The noble metal catalyst powder according to the second aspect of the present invention has the same structure of the noble metal catalyst powder according to the first aspect of the present invention other than having Rh (rhodium). As in the case for the first aspect of the present invention, the noble metal catalyst powder according to the second aspect of the present invention has the superior heat resistance and the superior oxidation resistance (stabilization in oxygen atmosphere), and the superior catalyst performance for a long period of time even if the noble metal catalyst powder is used under a strict condition such as high temperature environment.

Although the noble metal catalyst powder according to the second aspect of the present invention is composed of Pt (platinum) and Pd (palladium), without Rh (rhodium), it is possible to adequately keep the superior heat resistance and the superior durability because it contains Pd (palladium) as in the case for the first aspect of the present invention.

That is, according to the first aspect and the second aspect of the present invention, it is possible to provide the noble metal catalyst powder having the superior heat resistance and the superior durability. The noble metal catalyst powder according to the first aspect and the second aspect of the present invention can keep the catalyst performance for a long period of time.

In accordance with a third aspect of the present invention, there is provided a gas sensor element. The gas sensor element has a solid electrolyte with an oxygen ion conductivity, a target gas electrode formed on one surface of the solid electrolyte, a reference gas electrode formed on the other surface of the solid electrolyte, and a porous diffusion resistance layer which surrounds the target gas electrode. Through the porous diffusion resistance layer, a target gas moves and then reaches the target gas electrode. The noble metal catalyst powder is placed in the path through which the target gas to be detected passes through the porous diffusion resistance layer. The noble metal catalyst powder is the powder according to one of the first aspect and the second aspect of the present invention, as previously described.

In the gas sensor element according to the third aspect of the present invention, the noble metal catalyst powder according to one of the first aspect and the second aspect of the present invention is placed in the introduction path through which the target gas to be detected is introduced into the target gas chamber in which the target gas electrode is exposed.

The noble metal catalyst powder according to the first aspect and the second aspect of the present invention has the superior heat resistance and the superior durability and shows the catalyst performance for a long period of time. It is therefore possible for the noble metal catalyst powder in the gas sensor element to adequately burn hydrogen (H²) gas contained in the target gas to be detected. Further, it is possible for the gas sensor element to keep its catalyst performance, to reliably prevent incorrect detection such as output delay from generating, and to provide a long lifetime. This can provide the gas sensor element with superior durability and high detection reliability.

In accordance with a fourth aspect of the present invention, there is provided a gas sensor equipped with the gas sensor element previously described which is capable of detecting a concentration of a specific gas contained in the target gas to be detected emitted from an internal combustion engine.

The gas sensor according to the fourth aspect of the present invention is equipped with the gas sensor element having the noble metal catalyst powder. This gas sensor element in the gas sensor corresponds to the third aspect of the present invention. The noble metal catalyst powder corresponds to one of the first aspect and the second aspect of the present invention. The structure of the gas sensor according to the fourth aspect of the present invention makes it possible to reliably prevent incorrect detection such as output delay generated by the presence of hydrogen (H²) gas contained in the target gas from generating for a long period of time. The gas sensor according to the fourth aspect of the present invention has the superior durability and the high detection reliability.

### BRIEF DESCRIPTION OF THE DRAWINGS

A preferred, non-limiting embodiment of the present invention will be described by way of example with reference to the accompanying drawings, in which:

FIG. 1 is a perspective view showing a structure of a cylindrical quartz tube, in which various types of test samples of noble metal catalyst powder having a different composition of noble metal catalysts are placed in order to perform the evaluation test of the test samples in embodiments of the present invention;

FIG. 2 is a view showing the apparatus used for detecting a hydrogen purifying rate (%) of noble metal catalyst powder;

FIG. 3 is a view showing a relationship between a catalyst temperature (° C.) and a hydrogen purifying rate (%) of test samples of noble metal catalyst powder after completion of a durability test;

FIG. 4 is a view showing a relationship between the maximum standard deviation (mass %) and the purifying temperature T50 (° C.) of test samples of noble metal catalyst powder after a durability test, according to a second embodiment of the present invention;

FIG. 5 is a view showing a relationship between an average particle size (μm) and the purifying temperature T50(° C.) of noble metal alloy particles of test samples of noble metal catalyst powder after a durability test according to a third embodiment of the present invention;

FIG. 6 is a view showing a relationship between a total content (mass %) of Pd (Platinum) and Pd (palladium) and the purifying temperature T50(° C.) of test samples of noble metal catalyst powder after a durability test according to a fourth embodiment of the present invention;

FIG. 7 is a view showing a relationship between a specific surface area (m²/g) and the purifying temperature T50(° C.) of test samples of noble metal catalyst powder after a durability test according to a fifth embodiment of the present invention;

FIG. 8 is a view showing a cross section of a gas sensor element according to a sixth embodiment of the present invention;

FIG. 9 is a view showing a cross section of an outer surface part of a porous diffusion resistance layer formed in the gas sensor element shown in FIG. 8 according to the sixth embodiment of the present invention; and

FIG. 10 is a view showing a cross section of a gas sensor equipped with the gas sensor element according to the sixth embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

The noble metal catalyst powder according to the first aspect of the present invention is made of the noble metal alloy particles. The noble metal alloy particles are composed of an alloy containing Pt (platinum), Pd (palladium), and Rh (rhodium). That is, the noble metal alloy particles are composed basically of three types of elements, Pt (platinum), Pd (palladium), and Rh (rhodium) excepting inevitable impurity.

In particular, the noble metal alloy particle has an average particle size within a range of 0.2 μm to 2.0 μm. When the average particle size of the noble metal alloy particle is less than 0.2 μm, there is a possibility of easily evaporating noble metal in the noble metal alloy particle under a high temperature environment.

On the other hand, when the average particle size of the noble metal alloy particle exceeds 2.0 μm, there is a possibility of decreasing the catalyst performance of the noble metal catalyst because of decreasing the area of Pt (platinum) which is exposed on the surface of the noble metal alloy particle.

The standard deviation of the content (mass %) of each of the catalyst elements such as Pt (platinum), Pd (palladium), and Rh (rhodium) is not more than 20 mass % when the content (mass %) of each of the elements such as Pt (platinum), Pd (palladium), and Rh (rhodium) was detected at more than ten detection points which was optionally selected in the noble metal catalyst powder.

When the standard deviation of the content (mass %) of at least one of the elements, Pt (platinum), Pd (palladium), and Rh (rhodium), exceeds 20 mass %, it is difficult to adequately suppress the noble metal in the noble metal alloy particles from being evaporated under a high temperature environment.

It is therefore preferable to have the standard deviation of not more than 5.0 mass % in each of the catalyst elements, Pt (platinum), Pd (palladium), and Rh (rhodium) which form the noble metal alloy particles in order to provide the function of adequately suppressing the noble metal from being evaporated.

It is preferred that the total content of Pt (platinum) and Pd (palladium) in the entire content of the noble metal catalyst powder is not less than 40 mass %. This total content of Pt (platinum) and Pd (palladium) in the entire content of the noble metal catalyst powder according to the present invention provides the catalyst performance of Pt (platinum), Pd (palladium), and the oxidative resistance performance of Rh (rhodium) (stability of Rh in oxidative atmosphere).

When the total content of Pt (platinum) and Pd (palladium) in the entire content of the noble metal catalyst powder is less than 40 mass %, there is a possibility of being difficult for the noble metal catalyst powder to adequately show its catalyst performance, and for the Pd (Palladium) to adequately show its oxidative resistance performance. This has a possibility for the noble metal catalyst powder to not adequately show the improved durability.

In the second aspect of the present invention, the noble metal alloy particles forming the noble metal catalyst powder is the alloy which contains catalyst elements, Pt (platinum) and Pd (palladium). That is, the noble metal alloy particle is composed basically of two kinds of catalyst elements, namely, Pt (platinum) and Pd (palladium) excepting inevitable impurity.

The noble metal alloy particle forming the noble metal catalyst powder according to the second aspect of the present invention has an average particle size within a range of 0.2 μm to 2.0 μm. As in the case for the first aspect of the present invention, when the average particle size of the noble metal alloy particle is less than 0.2 μm, there is a possibility of easily evaporating noble metal in the noble metal alloy particle under a high temperature environment.

On the other hand, as in the case for the first aspect of the present invention, when the average particle size of the noble metal alloy particle exceeds 2.0 μm, there is a possibility for the catalyst performance of the noble metal catalyst powder to decrease because of decreasing the area of Pt (platinum) which is exposed on the surface of the noble metal alloy particle.

The standard deviation of the content (mass %) of each of the elements such as Pt (platinum) and Pd (palladium) is not less than 20 mass % when the content (mass %) of each of the catalyst elements, Pt (platinum) and Pd (palladium) is detected at more than ten detection points which was optionally selected in the noble metal catalyst powder by quantitative elemental analysis.

When the standard deviation of the content (mass %) of at least one of the catalyst elements, Pt (platinum) and Pd (palladium) exceeds 20 mass %, it is difficult to adequately suppress the noble metal in the noble metal alloy particle from being evaporated under a high temperature environment as in the case for the first aspect of the present invention.

It is preferable to have the standard deviation of not more than 5.0 mass % in each of the elements which form the noble metal alloy particle in order to provide the function for adequate suppressing the noble metal from being evaporated.

In the first aspect and the second aspect of the present invention, it is preferable to detect the noble metal catalyst powder at detection points, which are optionally selected, by using an electron microscope (EM), for example, SEM (scanning electron microscope) and an EDS (Energy Dispersive x-ray Spectroscopy).

This detection method using the EDS can quantify the composition and the scattering rate of the catalyst elements in the noble metal catalyst powder with high accuracy.

It is preferable for the noble metal catalyst powder to have a specific surface area of not less than 0.9 m²/g.

This structure of the noble metal catalyst powder can show its superior catalyst performance. Even if some of the specific surface area of the noble metal catalyst powder is decreased by evaporating the noble metal contained in the noble metal catalyst powder, it is possible to keep the specific surface area which is necessary to provide the catalyst performance. This can provide the effects of the present invention for improving the durability of the gas sensor element using the noble metal catalyst powder.

There is a possibility for the noble metal catalyst powder not to adequately provide its catalyst performance when the specific surface area of the noble metal catalyst powder is less than 0.9 m²/g.

It is better for the specific surface area of the noble metal catalyst powder to have the specific surface area of not less than 10 m²/g. Further, it is more preferable for the noble metal catalyst powder to have the specific surface area of not more than 35 m²/g in view of manufacturing the noble metal catalyst powder.

The third aspect of the present invention provides the gas sensor element using the noble metal catalyst powder according to one of the first aspect and the second aspect of the present invention. For example, the gas sensor element according to the third aspect of the present invention can be used as an A/F (Air/Fuel) sensor element, an oxygen sensor element, and a NOx sensor element when mounted to an exhaust gas pipe of an internal combustion engine of vehicles. The A/F sensor element detects an air and fuel (A/F) ratio on the basis of a limiting current generated corresponding to a concentration of an oxygen gas contained in a target gas to be detected such as an exhaust gas emitted from the internal combustion engine. The oxygen sensor element detects a concentration of oxygen gas contained in such an exhaust gas. The NOx sensor element can detect a concentration of environmental air pollutant such as NOx. The detected concentration of environmental pollution can be used for detecting deterioration of three way catalyst in a detection device which is placed in the exhaust gas pipe through which the exhaust gas emitted from an internal combustion engine to the outside of a vehicle.

It is possible to form the noble metal catalyst powder on the porous diffusion resistance layer of the gas sensor element, through which a target gas to be detected is passing, by using various configurations. For example, a layer containing alumina particles with which the noble metal catalyst powder is supported is formed on the outer surface of the porous diffusion resistance layer, where the target gas is introduced to an detection electrode in the gas sensor element through the outer surface of the porous diffusion layer. It is also possible to support the noble metal catalyst powder by other structures in the gas sensor element.

The fourth aspect of the present invention provides a gas sensor equipped with the gas sensor element having the noble metal catalyst powder previously described. For example, the gas sensor according to the fourth aspect of the present invention can be applied to A/F sensors, oxygen sensors, and NOx sensors.

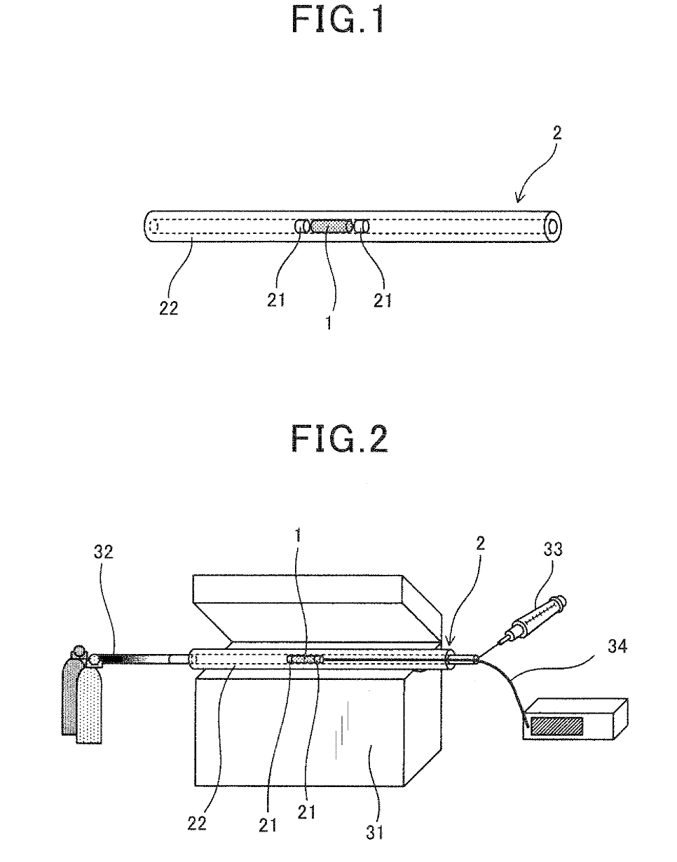

A description will be given of the first to sixth embodiments according to the present invention with reference to FIG. 1 to FIG. 10.

### First Embodiment

First embodiment shows the noble metal catalyst powder with reference to FIG. 1 to FIG. 3.

FIG. 1 is a perspective view showing a structure of a cylindrical quartz tube. The cylindrical quartz tube was used for detecting and evaluating various types of test samples of noble metal catalyst powder having a different composition of noble metal catalysts. That is, the cylindrical quartz tube was used for performing the evaluation test of the test sample in the following embodiments according to the present invention.

In the evaluation test, the first embodiment prepared a sample E11 and a comparison sample C11 of noble metal catalyst powder. The first embodiment detected and evaluated the catalyst performance of each of the sample E11 and the comparison sample C11.

As described above, the first embodiment prepared the sample E11 and the comparison sample C11 of the noble metal catalyst powder composed of noble metal alloy particles containing Pt (platinum), Pd (palladium), and Rh (rhodium) by using co-precipitation (CPT) method.

In preparing the sample E11 of noble metal catalyst powder according to the first embodiment, a reaction reagent was added into a solution obtained by mixing chloroplatinic acid, palladium chloride, and chloride rhodium to have the composition of 45 mass % of platinum (Pt), 45 mass % of Pd (palladium), and 10 mass % of Rh (rhodium). This made the sample E11 of the noble metal catalyst powder.

The sample E11of noble metal catalyst powder according to the first embodiment was detected at not less than ten detection points which were optionally selected in the noble metal catalyst powder by quantitative elemental analysis in order to detect the content (mass %) of each of Pt (platinum), Pd (palladium), and Rh (rhodium) in the noble metal catalyst powder of the sample E11.

The detection results show that the detected content of each of Pt (platinum), Pd (palladium), and Rh (rhodium) in the sample E11 is not more than 20 mass %. That is, the standard deviation of content of each of Pt (platinum), Pd (palladium), and Rh (rhodium) in the noble metal catalyst powder as the sample E11 according to the first embodiment was:

3.6 mass % of Pt (platinum);

3.4 mass % of Pd (palladium); and

2.0 mass % of Rh (rhodium).

The average particle size of the sample E11 was 0.42 μm.

On the other hand, the standard deviation of content of at least one of Pt (platinum), Pd (palladium), and Rh (rhodium) in the comparison sample C11 was more than 20 mass %. The standard deviation of content of each of Pt (platinum), Pd (palladium), and Rh (rhodium) in the noble metal catalyst powder as the comparison sample C11 was:

32.0 mass % of Pt (platinum);

28.0 mass % of Pd (palladium); and

4.0 mass % of Rh (rhodium).

The average particle size of the comparison sample C11 was 1.7 μm.

The above quantitative elemental analysis of the sample E11 and the comparison sample C11 of noble metal catalyst powder was performed at ten detection points which were optionally selected by using electron microscope (EM) and an energy dispersive x-ray spectroscopy (EDS) with an accelerating voltage kV corresponding to an electron voltage within a range of 10 to 20 eV.

The average value of content of each of Pt (platinum), Pd (palladium), and Rh (rhodium) was detected on the basis of the detection results of the above quantitative elemental analysis, and the standard deviation was obtained on the basis of the above average value of content.

The following Table 1 shows the detection results of the above quantitative elemental analysis of the sample E11of noble metal catalyst powder according to the first embodiment. As described above, the following detection results were obtained by detecting the sample E11 of noble metal catalyst powder at ten detection points which were optionally selected. The sample E11 of noble metal catalyst powder contained a small quantity of oxygen in addition to Pt (platinum), Pd (palladium), and Rh (rhodium).

TABLE 1

Content (mass %)

| Detection point No. | Pt | Pd | Rh | O |
|---|---|---|---|---|
| 1 | 21.5 | 68.6 | 8.4 | 1.5 |
| 2 | 21.7 | 65.3 | 13.0 | 0.0 |
| 3 | 20.2 | 64.2 | 14.6 | 1.0 |
| 4 | 20.5 | 66.5 | 12.0 | 1.0 |
| 5 | 18.9 | 68.3 | 11.5 | 1.3 |
| 6 | 11.0 | 74.8 | 12.0 | 2.2 |
| 7 | 18.8 | 71.2 | 9.0 | 1.0 |
| 8 | 19.9 | 69.1 | 10.0 | 1.0 |
| 9 | 24.5 | 63.8 | 10.9 | 0.8 |
| 10 | 23.1 | 65.2 | 9.2 | 2.5 |
| Average value (mass %) | 20.0 | 67.7 | 11.1 | 1.2 |
| Standard deviation (mass %) | 3.6 | 3.4 | 2.0 | 0.7 |

Next, the test for durability (or durability test) of noble metal catalyst powder was performed at a temperature of 1000° C. over 50 hours.

As shown in FIG. 1, the sample body 2 was prepared, in which the noble metal catalyst powder 1 after completion of the above durability test and the quartz wool 21 was placed in the quartz tune 22 of a cylindrical shape. The quartz wool was placed so that the noble metal catalyst powder 1 was hold at both sides of the quartz tune 22 of a cylindrical shape. The composition ratio of the noble metal catalyst powder and the quartz wool 21 was a rate of 0.02 g: 0.025 g.

Next, as shown in FIG. 2, the sample body 2 was placed in the tube furnace 31 which was maintained at a predetermined temperature, and an evaluation gas 32 was supplied to the sample body 2 in the quartz tube 22.

FIG. 2 is a view showing the apparatus to be used for detecting thee hydrogen purifying rates of noble metal catalyst powder.

The temperature in the tube furnace 31 was maintained within a range of room temperature and 500° C. The evaluation gas 32 was a balance gas composed of 5000 ppm of H₂, 2.5% (10 equivalent) of O₂, and N₂. The flowing rate of the evaluation gas 32 was 0.8 L/min.

Following this, 2 mL of the evaluation gas 32 passed through the quartz tube 22 having the sample body 2 was sampled by using the sampling apparatus 33 shown in FIG. 2. The temperature of the noble metal catalyst powder placed in the quartz tube 22 was detected by using a thermocouple 34. The sampled evaluation gas 32 of 2 mL was analyzed by gas chromatography (column: MS-5M (50° C.)) in order to detect a concentration of hydrogen (H₂) gas contained in the evaluation gas 32.

Next, as shown in FIG. 2, the hydrogen gas purifying rate of the evaluation gas 32 was detected by comparing the concentration of hydrogen contained in the evaluation gas 32 after passed through the noble metal catalyst powder 1 with the concentration of hydrogen contained in the evaluation gas 32 which was detected in advance before supplied into the sample body 2 placed in the quartz tune 22.

The relationship between the temperature and the hydrogen purifying rate of the noble metal catalyst powder 1 was calculated. Further, the special temperature of the noble metal catalyst powder 1 was detected, where this special temperature was the temperature of the noble metal catalyst powder 1 at which the hydrogen purifying rate of the noble metal catalyst powder 1 reaches 50%. This special temperature will be called to as the “purifying temperature T50 (° C.)”.

The second embodiment to fifth embodiment described later will use the purifying temperature T50 (° C.) as a standard temperature at which noble metal catalyst contained in the noble metal catalyst powder is activated.

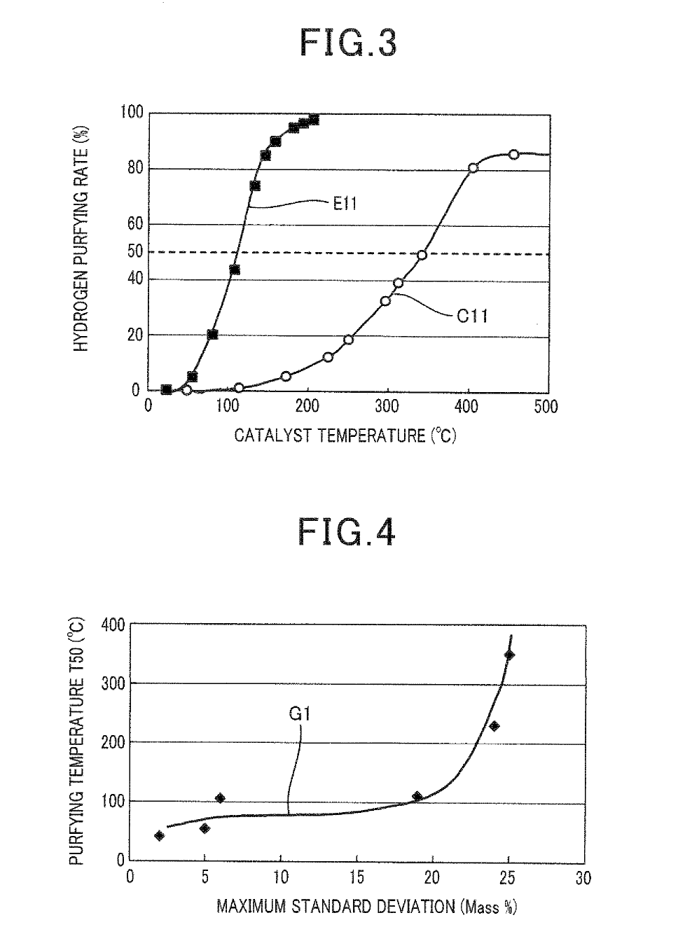

FIG. 3 is a view showing a relationship between the catalyst temperature (° C.) and the hydrogen purifying rate (%) of the test samples of noble metal catalyst powder after completion of the durability test.

As can be understood from FIG. 3, the sample E11of noble metal catalyst powder according to the first embodiment has a high hydrogen purifying rate after completion of the durability test even if a temperature of the catalyst contained in the noble metal catalyst powder is low when compared with the hydrogen purifying rate of the comparison sample C11.

Further, the purifying temperature T50(° C.) of the sample E11 of noble metal catalyst powder according to the first embodiment was 105° C. which is drastically lower than 345° C. of the purifying temperature T50(° C.) of the comparison sample C11. That is, the sample E11 of noble metal catalyst powder according to the first embodiment has the superior function for suppressing the noble metal from being evaporated, the low deterioration of the catalyst performance, and therefore provides the superior catalyst performance.

Next, a description will now be given of the actions and effects of the sample E11of noble metal catalyst powder according to the first embodiment.

The noble metal catalyst powder according to the first embodiment is composed of noble metal alloy particles containing Pt (platinum), Pd (palladium), and Rh (rhodium). That is, the first embodiment provides the noble metal alloy particles composed of:

Pt (platinum) having a superior catalyst performance;

Pd (palladium) having a high melting point, a superior heat resistance, and a superior oxidation resistance (stabilization in oxygen atmosphere), and;

Rh (rhodium) having a high melting point and a superior heat resistance.

The first embodiment provides the noble metal catalyst powder made of noble metal alloy particles capable of suppressing the noble metal (in particular, Pt (platinum)) from being evaporated at a high temperature under oxygen atmosphere.

In the first embodiment, the quantitative elemental analysis of Pt (platinum), Pd (palladium), and Rh (rhodium) was performed at not less than ten detection points which were optionally selected in the noble metal catalyst powder. The detection results of the noble metal catalyst powder according to the first embodiment show that the standard deviation of each of Pt (platinum), Pd (palladium), and Rh (rhodium) contained in the noble metal catalyst powder is not more than 20 mass %. The standard deviation shows the scattering ratio in composition between Pt (platinum), Pd (palladium), and Rh (rhodium) in the noble metal catalyst powder.

The noble metal catalyst powder according to the first embodiment is produced by using co-precipitation (CPT) method. In the CPT method, reducing agent is added into a mixture solution of chloroplatinic acid, palladium chloride, and chloride rhodium, and each of Pt (platinum), Pd (palladium), and Rh (rhodium) is simultaneously and uniformly deposited. The CPT method makes it possible to form the noble metal alloy powder of Pt (platinum), Pd (palladium), and Rh (rhodium) with a uniform content distribution and to decrease lack of uniformity in content of Pt (platinum), Pd (palladium), and Rh (rhodium) in the produced noble metal catalyst powder. This CPT method will be used in the second, third, fourth, and fifth embodiments described later in order to make various types of samples.

That is, the noble metal catalyst powder according to the first embodiment has the superior features in which each of Pt (platinum), Pd (palladium), and Rh (rhodium) is uniformly mixed in the noble metal catalyst powder in addition to making the alloy of Pt (platinum), Pd (palladium), and Rh (rhodium) while keeping the standard deviation of each of Pt (platinum), Pd (palladium), and Rh (rhodium) within not more than 20 mass %. This makes it possible to suppress the noble metal contained in the noble metal catalyst powder from being evaporated, and to provide the superior catalyst performance such as a superior heat resistance and a high duration for a long period of time and a long lifetime even if the noble metal catalyst powder of the sample E11 is used under a strict condition such as high temperature atmosphere.

The noble metal alloy particles forming the noble metal catalyst powder according to the first embodiment have the average particle size within the range of 0.2 μm to 2.0 μm. Having the above range of the average particle size of the noble metal alloy particles makes it possible to show the effect capable of suppressing the noble metal in the noble metal catalyst powder from being evaporated, and to keep the specific surface area of the noble metal alloy particles in the noble metal catalyst powder, and to provide the superior catalyst performance of the noble metal catalyst powder.

As described above in detail, the noble metal catalyst powder according to the first embodiment has the superior heat resistance, the superior durability, and the superior function for providing the catalyst performance for a long period of time even if the noble metal catalyst powder according to the first embodiment is used under various strict conditions.

Although the first embodiment shows the of noble metal catalyst powder made of noble metal alloy particles composed mainly of Pt (platinum), Pd (palladium), and Rh (rhodium). However, the concept of the present invention is not limited by the first embodiment. For example, it is possible to use the noble metal catalyst powder made of noble metal alloy particles composed of Pt (platinum) and Pd (palladium).

### Second Embodiment

A description will be given of the noble metal catalyst powder according to the second embodiment of the present invention with reference to FIG. 4. The second embodiment prepared a plurality of test samples of the noble metal catalyst powder having a different maximum standard deviation in content of each of the elements such as Pt (platinum), Pd (palladium), and Rh (rhodium). This maximum standard deviation is the maximum value in the standard deviation of content of each of the elements such as Pt (platinum), Pd (palladium), and Rh (rhodium) contained in the noble metal catalyst powder.

The second embodiment made a plurality of the test samples of noble metal catalyst powder having a different maximum standard deviation. Each of the test samples of the noble metal catalyst powder used in the second embodiment was made of noble metal alloy particles containing Pt (platinum), Pd (palladium), and Rh (rhodium). The noble metal alloy particles in the noble metal catalyst powder had the composition of 45 mass % of Pt (platinum), 45 mass % of Pd (palladium), and 10 mass % of Rh (rhodium). The average particle size of the noble metal alloy particles was within a range of 0.2 μm to 2.0 μm.

Next, the second embodiment performed the durability test of the noble metal catalyst powder according to the second embodiment at a temperature of 1000° C. over 50 hours, as in the case for the first embodiment, as previously described.

The second embodiment detected the purifying temperature T50(° C.) of the noble metal catalyst powder after completion of the above durability test.

FIG. 4 is a view showing a relationship between the maximum standard deviation (mass %) and the purifying temperature T50 (° C.) of the test samples of noble metal catalyst powder after completion of the durability test according to the second embodiment of the present invention.

In FIG. 4, reference character “♦” designates the purifying temperature T50(° C.) after completion of the durability test to the maximum standard deviation (mass %) of the noble metal catalyst powder. Reference character “G1” indicates an approximate curve of the purifying temperature T50(° C.).

As can be understood from FIG. 4, when the maximum standard deviation of the noble metal catalyst powder is not more than 20 mass % (the standard deviation of composition of each of Pt (platinum), Pd (palladium), and Rh (rhodium) is not more than 20 mass %), the purifying temperature T50(° C.) of the noble metal catalyst powder becomes a low temperature near and/or below 100° C. That is, the noble metal catalyst powder according to the second embodiment has the effect which suppresses the noble metal from being evaporated, and is capable of providing a low deterioration of the catalyst performance after completion of the durability test. Thus, the noble metal catalyst powder according to the second embodiment adequately shows the superior catalyst performance.

On the other hand, as shown in FIG. 4, when the standard deviation (mass %) of the content of at least one of the elements, Pt (platinum), Pd (palladium), and Rh (rhodium) exceeds 20 mass %, the purifying temperature T50(° C.) of the noble metal catalyst powder is rapidly increased after completion of the durability test. That is, it is difficult to adequately suppress the noble metal in the noble metal catalyst powder from being evaporated under a high temperature environment. This case has a large deterioration of the catalyst performance after completion of the durability test.

As described above, it is possible for the noble metal catalyst powder according to the second embodiment to provide the superior heat resistance, the superior durability, and the superior catalyst performance for a long period of time because of being composed of Pt (platinum), Pd (palladium), and Rh (rhodium) has the maximum standard deviation of not more than 20 mass % in each of Pt (platinum), Pd (palladium), and Rh (rhodium).

Although the second embodiment shows the noble metal catalyst powder composed of noble metal alloy particles of Pt (platinum), Pd (palladium), and Rh (rhodium). However, the concept of the present invention is not limited by the composition of the noble metal catalyst powder according to the second embodiment. For example, it is possible to use the noble metal catalyst powder composed of noble metal alloy particles composed mainly of Pt (platinum) and Pd (palladium).

### Third Embodiment

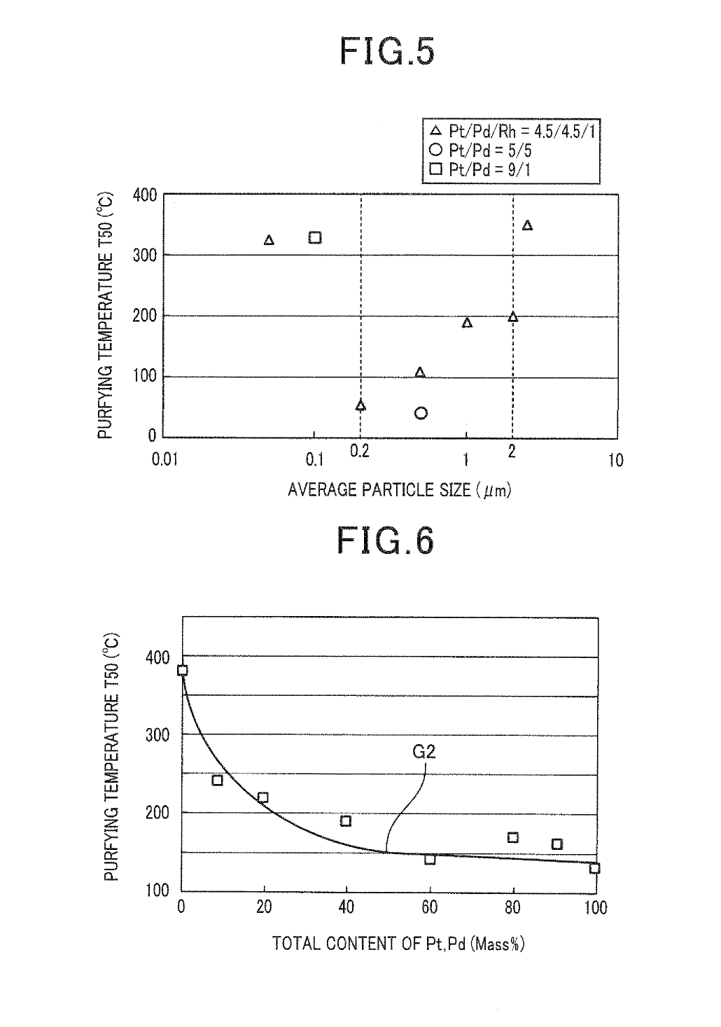

A description will be given of the noble metal catalyst powder according to the third embodiment of the present invention with reference to FIG. 5. The third embodiment shows a plurality of test samples of the noble metal catalyst powder having a different average particle size (μm).

As shown in Table 2, the third embodiment prepared a plurality of the test samples 21 to 28 of noble metal catalyst powder having a different average particle size (μm).

Table 2 shows the composition ratio and the average particle size of each of the noble metal catalyst powder. In particular, all of the test samples 21 to sample 28 have the standard deviation in content of each of the elements such as Pt (platinum), Pd (palladium), and Rh (rhodium) was not more than 20 mass %.

Next, the third embodiment performed the durability test of the noble metal catalyst powder at 1000° C. over 50 hours, and detected the hydrogen purifying rate (%) of the noble metal catalyst powder. The third embodiment finally detected the purifying temperature T50(° C.) of the noble metal catalyst powder.

Table 2 shows the detection results of the noble metal catalyst powder according to the samples 21 to 28 according to the third embodiment of the present invention.

TABLE 2

| Sample | Composition | Average particle | Purifying temperature |
|---|---|---|---|
| No. | ratio | size (μm) | T50 (° C.) |
| 21 | Pt/Pd/Rh = 4.5/4.5/1 | 0.05 | 325 |
| 22 | Pt/Pd/Rh = 4.5/4.5/1 | 0.2 | 55 |
| 23 | Pt/Pd/Rh = 4.5/4.5/1 | 0.5 | 110 |
| 24 | Pt/Pd/Rh = 4.5/4.5/1 | 1.0 | 190 |
| 25 | Pt/Pd/Rh = 4.5/4.5/1 | 2.0 | 200 |
| 26 | Pt/Pd/Rh = 4.5/4.5/1 | 2.5 | 350 |
| 27 | Pt/Pd = 5/5 | 0.5 | 42 |
| 28 | Pt/Pd = 9/1 | 0.1 | 330 |

FIG. 5 is a view showing a relationship between an average particle size and the purifying temperature T50 (° C.) of the noble metal alloy particles of the noble metal catalyst powder after the durability test according to the third embodiment of the present invention.

FIG. 5 shows the purifying temperature T50 (° C.) of the noble metal catalyst composed of the noble metal alloy particles containing Pt (platinum), Pd (palladium), and Rh (rhodium). In FIG. 5, reference character “Δ” represents the test samples 21 to 26 having the composition ratio of Pt/Pd/Rh=4.514.5/1, reference character “◯” designates the test sample 27 having the composition ratio of Pt/Pd=5/5, and reference character “□” indicates the test sample 28 having the composition ratio Pt/Pd=9/1.

As can be understood from FIG. 5, the test sample of the noble metal catalyst powder having the average particle size within the range of 0.2 μm to 2.0 μm provides the purifying temperature T50 (° C.) of not more than 200° C. This condition of not more than 200° C. is preferable and better in use. That is, these samples can provide the superior function of suppressing the noble metal from being evaporated, the superior catalyst performance, a low deterioration of the catalyst performance even after the durability test.

On the other hand, the test samples 21, 26, and 28 having the average particle size of less than 0.2 μm or more than 2.0 μm provide the purifying temperature T50 (° C.) of more than 200° C. after the durability test. This is difficult to adequately suppress the noble metal from being evaporated, and provides large deterioration of the catalyst performance after the durability test.

As described above, the noble metal catalyst powder having the average particle size within the range of 0.2 μm to 2.0 μm according to the third embodiment provides the superior heat resistance, the superior durability, and the superior catalyst performance for a long period of time.

### Fourth Embodiment

A description will be given of the catalyst performance of the noble metal catalyst powder having a different content of Pt (platinum) and Pd (palladium) with reference to FIG. 6.

The fourth embodiment prepared a plurality of test samples of noble metal catalyst powder having a different total content of Pt (platinum) and Pd (palladium).

The noble metal catalyst powder is composed of noble metal alloy particles of Pt (platinum), Pd (palladium), and Rh (rhodium). Each of the test samples has the standard deviation of not more than 20 mass % in content of each of Pt (platinum), Pd (palladium), and Rh (rhodium). Further, each of the test samples is composed of noble metal alloy particles having the average particle size of 0.2 μm.

Next, as in the case for the method according to the first embodiment previously described, the durability test of the test samples of the noble metal catalyst powder was performed at 1000° C. over 50 hours. The hydrogen purifying rate (%) of the samples of noble metal catalyst powder was detected. The purifying temperature T50 (° C.) of the test samples of noble metal catalyst powder after the durability test was obtained on the basis of the obtained hydrogen purifying rate (%). FIG. 6 shows the obtained purifying temperature T50 (° C.) of each of the test samples of noble metal catalyst powder after completion of the durability test.

That is, FIG. 6 is a view showing the relationship between the total content of Pd (Platinum) and Pd (palladium) in each of the test samples of noble metal catalyst powder and the purifying temperature T50 (° C.) after completion of the durability test according to the fourth embodiment of the present invention.

In FIG. 6, reference character “□” designates the purifying temperature T50(° C.) after completion of the durability test in the total content (mass %) of Pt (platinum) and Pd (palladium) in each of the samples of noble metal catalyst powder. Reference character “G2” indicates an approximate curve of the obtained purifying temperature T50(° C.) of each of the samples.

As can be understood from FIG. 6, when the total content of Pt (platinum) and Pd (palladium) in noble metal catalyst powder is not less than 40 mass %, the purifying temperature T50 (° C.) becomes not more than 200° C. which is a preferable value in actual use. That is, this condition makes it possible to adequately show the superior catalyst performance of Pt (platinum) and the oxidative resistance performance of Pd (palladium) (stabilization in oxidative atmosphere).

On the other hand, when the total content of Pt (platinum) and Pd (palladium) in noble metal catalyst powder is less than 40 mass %, there is a possibility for the purifying temperature T50 (° C.) to be rapidly increased after the durability test, namely, to exceed 200° C. This is difficult to adequately show the superior catalyst performance of Pt and the oxidative resistance performance of Pd (palladium). This has a possibility for the noble metal catalyst powder not to adequately show the improved durability.

It is therefore preferable for the noble metal catalyst powder to have the total content of Pt (platinum) and Pd (palladium) of not less than 40 mass %.

### Fifth Embodiment

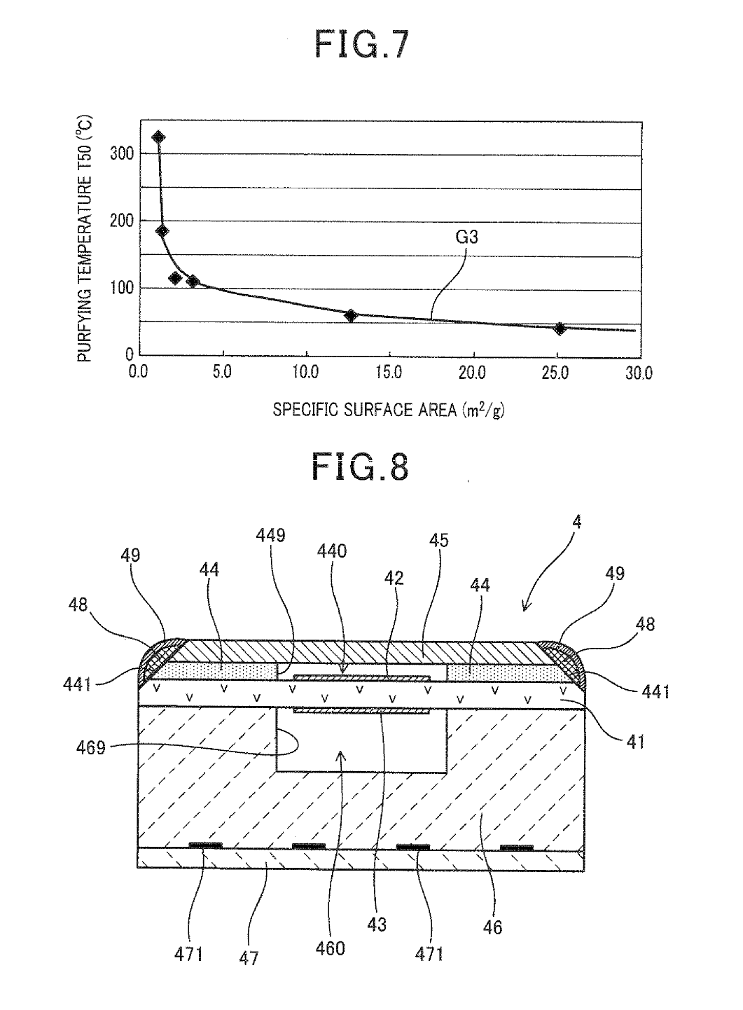

A description will be given of the noble metal catalyst powder according to the fifth embodiment of the present invention with reference to FIG. 7. The fifth embodiment shows a plurality of test samples of the noble metal catalyst powder having a different specific surface area (m²/g).

The fifth embodiment prepared a plurality of test samples 31 to 36 of noble metal catalyst powder. Table 3 shows the test samples 31 to 36 used in the fifth embodiment. The noble metal catalyst powder forming each of the test sample 31 to 36 is composed of noble metal alloy particles containing Pt (platinum), Pd (palladium), and Rh (rhodium). Table 3 further show the compositional ratio of Pt (platinum), Pd (palladium), and Rh (rhodium) in each of the test samples 31 to 36 made of noble metal catalyst powder. Table 3 further shows the specific surface area (m²/g) of each of the test samples 31 to 36 made of noble metal catalyst powder.

In particular, the standard deviation in content of each of Pt (platinum), Pd (palladium), and Rh (rhodium) in each of the test samples 31 to 36 had not more than 30%. Further, each of the test samples 31 to 36 had the average particle size within a range of 0.2 μm to 2.0 μm.

Next, as in the method for the first embodiment, the durability test of the test samples 31 to 36 was performed at 1000° C. over 50 hours. The hydrogen purifying rate (%) of each of the test samples 31 to 36 was detected, and the purifying temperature T50 (° C.) was calculated on the basis of the detected hydrogen purifying rate (%). Table 3 and FIG. 7 show the calculation results of each of the test samples 31 to 36.

TABLE 3

| Sample | | Specific surface | Purifying |
|---|---|---|---|
| No. | Composition ratio | area (m²/g) | temperature T50 (° C.) |
| 31 | Pt/Pd/Rh = 4.5/4.5/1 | 25.0 | 45 |
| 32 | Pt/Pd/Rh = 4.5/4.5/1 | 12.7 | 55 |
| 33 | Pt/Pd/Rh = 4.5/4.5/1 | 2.7 | 105 |
| 34 | Pt/Pd/Rh = 4.5/4.5/1 | 1.5 | 115 |
| 35 | Pt/Pd/Rh = 4.5/4.5/1 | 0.9 | 185 |
| 36 | Pt/Pd/Rh = 4.5/4.5/1 | 0.4 | 325 |

FIG. 7 is a view showing a relationship between the specific surface area (m²/g) and the purifying temperature T50 (° C.) of each of the test samples 31 to 36 after completion of the durability test according to the fifth embodiment of the present invention.

In FIG. 7, reference character “♦” designates the purifying temperature T50(° C.) after completion of the durability test in the specific surface area (m²/g) of noble metal catalyst powder in each of the test samples 31 to 36, and reference character “G3” indicates an approximate curve of the obtained purifying temperature T50(° C.).

Because having the specific surface area (m²/g) of not less than 0.9 (m²/g), the purifying temperature T50 (° C.) of each of the test samples 31 to 35 becomes not more than 200° C. which is a preferable and better value in actual use. That is, this condition of each of the test samples 31 to 35 makes it possible to adequately show the superior catalyst performance of Pt (platinum) and the oxidative resistance performance of Pd (palladium) (stabilization in oxidative atmosphere).

On the other hand, because the test sample 36 had the specific surface area of less than 0.9 m²/g, the purifying temperature T50 (° C.) was rapidly increased and exceeds 200° C. The condition of the test sample 36 makes it difficult to adequately show the superior catalyst performance of noble metal catalyst powder. The test sample 36 cannot adequately show the catalyst performance.

Accordingly, it is preferable for the noble metal catalyst powder to have the specific surface area of not less than 0.9 m²/g. Further, it is more preferable in actual use for the noble metal catalyst powder to have the specific surface area of not less than 10 m²/g in order to adequately show the catalyst performance. Still further, it is more preferable in the viewpoint of manufacturing process for the noble metal catalyst powder to have the specific surface area of not more than 35 m²/g.

Although the fifth embodiment shows the test samples 31 to 35 made of noble metal catalyst powder made of noble metal alloy particles composed mainly of Pt (platinum), Pd (palladium), and Rh (rhodium). However, the concept of the present invention is not limited by the fifth embodiment. For example, it is possible to use the noble metal catalyst powder made of noble metal alloy particles composed of Pt (platinum) and Pd (palladium).

### Sixth Embodiment

A description will be given of a gas sensor element and a gas sensor equipped with the gas sensor element according to the sixth embodiment of the present invention with reference to FIG. 8 to FIG. 10. The gas sensor element according to the sixth embodiment uses the noble metal catalyst powder according to the first to fifth embodiments.

FIG. 8 is a view showing a cross section of the gas sensor element 4 according to the sixth embodiment of the present invention. As shown in FIG. 8, the gas sensor element 4 is built in a gas sensor such as an air fuel gas sensor (A/F sensor). The A/F sensor is capable of detecting the air fuel ratio on the basis of a limiting current which corresponds to an oxygen concentration in a target gas such as an exhaust gas emitted from an internal combustion engine mounted to a vehicle. The gas sensor having such a structure will be explained later in detail.

The gas sensor element 4 shown in FIG. 8 is composed mainly of a solid electrolyte 41, a target gas electrode 42, a reference gas electrode 43, a porous diffusion resistance layer 44. The solid electrolyte 41 has an oxygen ion conductivity. The target gas electrode 42 is formed on one surface of the solid electrolyte 41. The reference gas electrode 43 is formed on the other surface of the solid electrolyte 41.

As shown in FIG. 8, the porous diffusion resistance layer 44 surrounds the target gas electrode 42. Through the porous diffusion resistance layer 44, the target gas to be detected such as an exhaust gas emitted from an internal combustion engine passes through the porous diffusion resistance layer 44, and reaches the target gas electrode 42.

As shown in FIG. 8, a reference gas chamber forming layer 46 is formed at the reference gas electrode 43 side on the solid electrolyte 41. The reference gas chamber forming layer 46 is made of alumina having electrical insulation characteristics. The reference gas chamber forming layer 46 prevents gases from passing therein. A groove part 469 is formed in the reference gas chamber forming layer 46. The groove part 469 forms the reference gas chamber 460 into which atmosphere as a reference gas is introduced.

A heater substrate 47 is stacked on the surface of the reference gas chamber forming layer 46 which is opposite to the surface on which the solid electrolyte 41 is stacked. Heating parts 471 are formed on the heater substrate 47 so that the heating parts 471 face the reference gas chamber forming layer 46.

As shown in FIG. 8, the porous diffusion resistance layer 44 is formed on the solid electrolyte 41 around the target gas electrode 42. The porous diffusion resistance layer 44 is made of porous alumina having pores capable of permeating the target gas.

A shielding layer 45 is stacked on the surface of the porous diffusion resistance layer 44 which is opposite to the surface where the solid electrolyte 41 is formed. The shielding layer 45 has electric insulation characteristics, and a dense structure capable of preventing gas from being passing therein. As shown in FIG. 8, the shielding layer 45, the opening part 449 of the porous diffusion resistance layer 44, and the solid electrolyte 41 make the target gas chamber 440. The target gas such as exhaust gas to be detected is introduced to the inside of the target gas chamber 440.

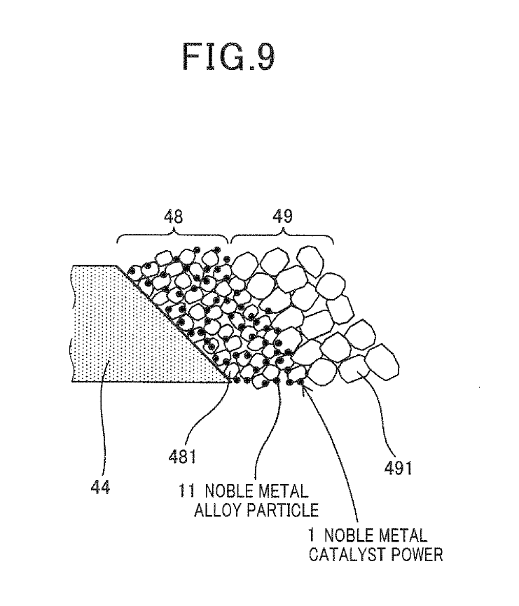

FIG. 9 is a view showing a cross section of the outer surface part of the porous diffusion resistance layer 44 formed in the gas sensor element 4 shown in FIG. 8 according to the sixth embodiment of the present invention.

As shown in FIG. 8 and FIG. 9, a catalyst layer 48 and a protection trap layer 49 are formed on the outer surface of the gas sensor element 4. The catalyst layer 48 has the catalyst performance. The protection trap layer 49 is capable of trapping catalyst-poisoning material contained in the target gas.

As shown in FIG. 9, the catalyst layer 48 is made of alumina particles 481 which support noble metal catalyst powder 1 composed of the noble metal alloy particles 11, as previously described in the first to fifth embodiments according to the present invention. The protection trap layer 49 is made of alumina particles 491 which are larger in particle size than the alumina particles contained in the catalyst layer 48.

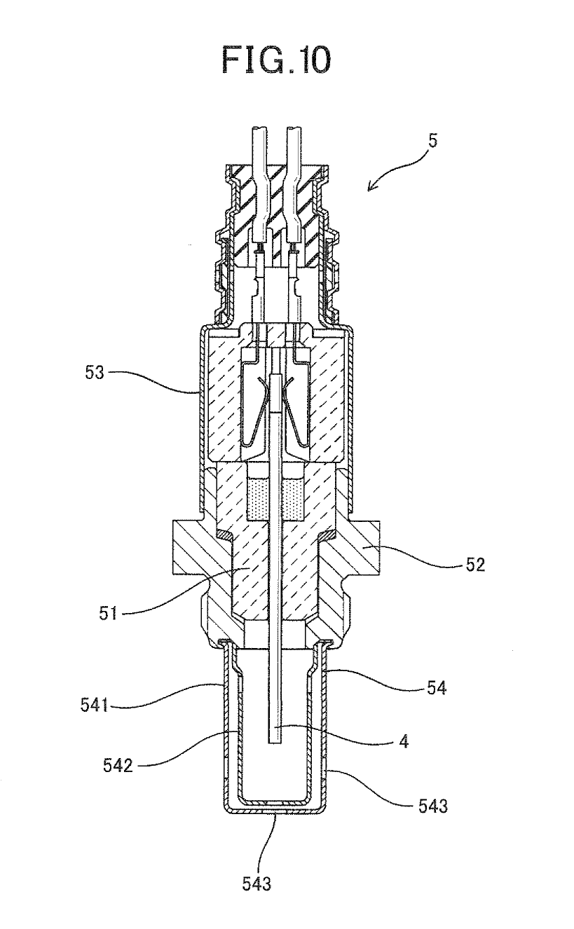

Next, a description will now be given of the gas sensor 5 equipped with the gas sensor element 4 having the structure described above with reference to FIG. 10.

FIG. 10 is a view showing a cross section of the gas sensor 5 equipped with the gas sensor element 4 according to the sixth embodiment of the present invention.

As shown in FIG. 10, the gas sensor 5 according to the sixth embodiment is an A/F sensor capable of detecting an air fuel ratio (A/F ratio) on the basis of a limiting current which corresponds to an oxygen concentration in a target gas such as an exhaust gas emitted from an internal combustion engine mounted to a vehicle.

The gas sensor 5 is comprised of an insulation glass 51 as an insulator, a housing 52, an atmosphere cover case 53, an element cover case 54, and the gas sensor element 4 shown in FIG. 8 and FIG. 9. The insulation glass 51 accommodates the gas sensor element 4 and supports it in the inside thereof. The housing 52 accommodates the insulation glass 51 and supports it in the inside thereof. The atmosphere cover case 53 is placed at the rear end side of the housing 52 in the gas sensor 5. The atmosphere cover case 53 maintains and fixes the housing 52 to the inner diameter direction at a base side of the housing 52. The element cover case 54 is placed at the front end side of the housing 52 to protect the gas sensor element 4 from damage to be applied from outside.

As shown in FIG. 10, the element cover case 54 is a double structure cover case comprised of an outer cover case 541 and an inner cover case 542. Gas inlet holes 543 are formed in the side surface and the bottom surface of each of the outer cover case 541 and the inner cover case 542. Through the gas inlet holes 543, the target gas to be detected is introduced inside of the gas sensor 5. The front end side of the gas sensor 5 indicates the part through which the target gas to be detected in introduced into the inside of the gas sensor 5. The rear end is the part which is opposite to the front end in the gas sensor 5.

Next, a description will now be given of the action and effects of the gas sensor 5 equipped with the gas sensor element 4 according to the sixth embodiment.

In the gas sensor element 4 according to the sixth embodiment, the noble metal catalyst powder 1 according to the first to fifth embodiments is placed in the introduction path through which the target gas to be detected is introduced into the target gas chamber 440 in which the target gas electrode 42 is exposed.

As previously described in the explanation of the first to fifth embodiments, because the noble metal catalyst powder 1 has the superior heat resistance and the superior durability, and shows the catalyst performance for a long period of time, it is possible for the noble metal catalyst powder 1 in the gas sensor element 4 to adequately burn hydrogen gas contained in the target gas. Further, it is possible for the gas sensor element 4 to maintain its catalyst performance and to reliably prevent incorrect detection such as output delay from generating for a long period of time. This can provide the gas sensor element 4 with superior durability and high detection reliability.

In addition, the gas sensor according to the sixth embodiment is equipped with the built-in gas sensor element 4 having the noble metal catalyst powder 1 according to the first to fifth embodiments. This structure of the gas sensor 5 makes it possible to reliably prevent incorrect detection such as output delay caused by the presence of hydrogen gases contained in the target gas from generating for a long period of time. The gas sensor 5 according to the sixth embodiment has the superior durability and high detection reliability.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A noble metal catalyst powder comprised of noble metal alloy particles containing platinum, palladium, and rhodium, wherein the noble metal alloy particles have an average particle size within a range of 0.2 μm to 2.0 μm, and a standard deviation in content of each of platinum, palladium, and rhodium is not more than 20 mass %, where the standard deviation in content is detected at not less than ten detection points of the noble metal catalyst powder by quantitative elemental analysis.

2. The noble metal catalyst powder according to claim 1, wherein a total content of platinum and palladium in the noble metal catalyst powder is not less than 40 mass %.

3. A noble metal catalyst powder comprised of noble metal alloy particles containing platinum and palladium, wherein the noble metal alloy particles have an average particle size within a range of 0.2 μm to 2.0 μm, and a standard deviation in content of each of platinum and palladium is not more than 20 mass %, where the standard deviation in content is detected at not less than ten detection points of the noble metal catalyst powder by quantitative elemental analysis.

4. The noble metal catalyst powder according to claim 1, wherein the noble metal catalyst powder has a specific surface area of not less than 0.9 m²/g.

5. The noble metal catalyst powder according to claim 3, wherein the noble metal catalyst powder has a specific surface area of not less than 0.9 m²/g.

6. A gas sensor element comprising:
a solid electrolyte with an oxygen ion conductivity;
a target gas electrode formed on one surface of the solid electrolyte;
a reference gas electrode formed on the other surface of the solid electrolyte;
a porous diffusion resistance layer surrounding the target gas electrode, through which a target gas passes and reach the target gas electrode; and
noble metal catalyst powder placed in a path through which the target gas to be detected is passed into the porous diffusion resistance layer, wherein the noble metal catalyst powder is composed of noble metal alloy particles containing platinum and at least one of palladium and rhodium, the noble metal alloy particles have an average particle size within a range of 0.2 μm to 2.0 μm, and a standard deviation in content of each of platinum, palladium, and rhodium is not more than 20 mass %, where the standard deviation in content is detected at not less than ten detection points of the noble metal catalyst powder by quantitative elemental analysis.

7. A gas sensor equipped with the gas sensor element according to claim 6 capable of detecting a concentration of a specific gas contained in a target gas to be detected.
